(19) United States
(12) Patent Application Publication
(10) Pub. No.: US 2005/0091584 A1
(43) Pub. Date: Apr. 28, 2005

(54) Methods for applying styles to visual aspects of user interface elements

(75) Inventors: Jeffrey L. Bogdan, Redmond, WA (US); Sundaram Ramani, Redmond, WA (US); Henry Hahn, Bellevue, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/692,924

(22) Filed: Oct. 23, 2003

(51) Int. Cl. G06F 17/00

(52) U.S. Cl. 715/514

(57) ABSTRACT

The visual appearance of a user interface element can be specified in a visual style document divorced from its semantic implementation. The visual style document can be used to specify a visual style including a set of sub-elements used for composing composite user interface element. Selected properties of the sub-elements may be exposed as properties of the composite element itself such that values specified for properties of the composite user interface element can be consumed by corresponding properties of the sub-elements. The style document can also be used to specify values for selected visual properties described in a named resource that may be independent of the style document. Changes in functional aspects of selected sub-elements of composite user interface elements can be used to drive changes in properties of the composite user interface element or other sub-elements by triggering commands that the other elements may be responsive to.

### TECHNICAL FIELD

The technical field relates to visual representations of user interface elements of a computer program. More particularly, the field relates to various methods for applying visual styles to user interface elements.

### BACKGROUND

With the proliferation of computers has come innovation in the area of software user interfaces. For example, there are many tools now available by which user interfaces can be created and manipulated by programmers. A typical user interface comprises of several elements (e.g., a dialog box comprising one or more list boxes, buttons etc.). Furthermore, user interface elements (also, commonly referred to as controls) can now be placed in documents, such as web pages or word processing documents. Thus, creating user interface elements (hereafter, “UI elements”) is no longer only in the realm of sophisticated computer programming.

UI elements can take many forms: edit boxes, list boxes, scroll bars, pick lists, pushbuttons, radio buttons and the like. Although the individual elements of a user interface (e.g., radio button) may appear to the user as a single composite item, it may actually be represented in the computer as a number of separate items or sub-elements that have been combined together. Furthermore, each of these sub-elements themselves can be composed from other sub-elements. In this manner, UI elements can serve as building blocks for building other, more complex, UI elements. Such an approach is useful because the software managing the user interface (e.g., the user interface framework) can re-use the definitions of certain common elements when assembling them into composite elements.

However, the complexity introduced by representing UI elements as composite UI elements can be problematic. For example, new or casual programmers may not wish to acquaint themselves with how a composite UI element is assembled, or even that the composite UI element is a composite in the first place. Although, certain class of programmers may prefer to avoid such complexity they may however, desire an increased amount of control over the design of the UI element, particularly its visual style, look or appearance to an end user.

Traditional user interface frameworks combined the functional aspects (i.e., semantics such as its behavior regarding events handling, and other aspects of interacting with an end user etc.) along with the visuals aspects (i.e., its appearance or look to an end user) of the UI elements definition (e.g., in its object model). Thus, changing the appearance or style of a UI element independently of its functional behavior was generally out of reach of a casual programmer because he or she would need to understand and account for the strong contract that existed between a UI element's visual and functional aspects. Several solutions available today partly address the need for a simplified programming model for applying new styles to UI elements (e.g., Windows Forms by Microsoft® Corporation of Redmond, Wash.). However, the models such as the Windows Forms programming model is not flexible enough to accommodate both casual programmers as well as sophisticated programmers who may desire to radically alter the visual style of a UI element.

Thus, there is a need for a user interface framework which not only provides methods for a casual programmer to have increased control over the visual style or appearance of a UI element but also provides for methods whereby a sophisticated programmer with a more in-depth knowledge of the UI element's structure can radically alter its appearance or style.

### SUMMARY

Described herein is a simplified process for providing increased flexibility in specifying visual aspects of a user interface element for its rendering independent of its semantic implementation. For example, the object model for a user interface element may be initially defined as lookless without any of its visual properties specified. Later, a document comprising a description of the visual style including, but not limited to, any sub-elements used for composing the user interface element may be associated with the user interface element's object model to render the user interface element according to the visual style described in the document.

In one implementation, visual properties consumed by sub-elements used for composing a composite user interface element are exposed in a logical representation as properties of the composite user interface element. Thus, simplified logical models of user interface elements may be provided so that values for visual properties of the sub-elements can be specified without need to fully comprehend the composition of composite user interface elements. For example, in a visual style document assigned to a composite user interface element, sub-elements that may be needed for composing a composite user interface element may be listed in a form of visual tree structure wherein selected properties of the sub-elements are bound to corresponding properties of the composite user interface element. Through these bindings values of properties of the lower sub-elements may be specified directly by specifying values of the composite user interface element.

Furthermore, in a visual style document, values for selected visual properties of the composite user interface element itself or its sub-elements may be specified by associating the selected visual property with a named resource that is independent of the style document itself. In this manner, changes to values of properties assigned to named resources can drive changes to the visual style without the need to alter the visual style document itself. This makes the process of maintaining a uniform look and feel associated with a theme for the user interfaces much more simple. For example, this feature may be used to apply styles for sub-elements within the style document of a composite element by simply naming a style that is defined elsewhere. Also, nesting of named style references provides a powerful tool for making significant changes to visual properties of a large number of user interface elements without the need to individually alter each and every one of their visual style documents.

In yet another implementation, a visual style document can be used to selectively connect sub-elements of a composite user interface element to their respective composite user interface element in a loose contract that allows for changes in functional aspects of a sub-element to drive changes in the visual aspects of the composite user element interface itself. In one implementation, this may be specified as a declarative command statement that is triggered upon a specified change in the functional aspect of the sub-element (e.g., click event) that could then be communicated higher up the visual tree wherein the composite user interface element that is responsive to the command can respond to the command by implementing a change in one or more of its properties. In one example, such a change in the value of a composite user interface element may actually be consumed by a sub-element bound to the composite element.

Additional features and advantages will be made apparent from the following detailed description of illustrated embodiments, which proceeds with reference to the accompanying drawings.

### BRIEF DESCRIPTION OF DRAWINGS

FIG. 1 is a block diagram illustrating an exemplary user interface element.

FIG. 2 is a block diagram illustrating an object model for a user interface element with its visual and functional aspects tied together by a tight contract.

FIG. 3 is a block diagram illustrating an object model for a user interface element with its visual and functional aspects connected to each other by a loose contract through a styling interface.

FIG. 4 is a block diagram illustrating a method of applying a selected visual style for converting an initially lookless user interface model to be rendered as a user interface depicting the selected visual style.

FIG. 5A is a block diagram illustrating the visual style of an exemplary user interface element before and after application of a selected style.

FIG. 5B is a listing in a mark-up language describing a visual style to be applied to a button type user interface element.

FIG. 5C is a listing in a mark-up language instructing an exemplary user interface framework to apply a selected style (MyButtonStyle) to a button type user interface element.

FIG. 6A is a block diagram illustrating another example of a simple button type user interface element.

FIG. 6B is a block diagram illustrating an example of a visual tree of a button type user interface element comprising sub-elements that may be used to compose a visual style of the composite button type user interface element.

FIG. 7 is a block diagram illustrating an example of a logical tree associated with a button type user interface that is shown with some of the sub-elements composing the visual tree of the button type user interface element obscured in the logical tree.

FIG. 8 is a block diagram illustration of a visual tree of sub-elements used for composing the visual style of a button type user interface element shown with examples of visual properties that may be associated with each of the sub-elements.

FIG. 9 is a block diagram illustrating data bindings in a visual style document that allow visual properties that are actually consumed by sub-elements of a composite user interface element to be exposed as properties of the composite user interface element itself.

FIG. 10 is a listing in a mark-up language of a visual style associated with a button type user interface element that describes the bindings shown in FIG. 9.

FIG. 11 is a block diagram illustrating an exemplary composite vertical scroll bar user interface element with one of its component sub-elements associated with a named style.

FIG. 12 is a block diagram of a hierarchical tree representation of the sub-elements of a scroll bar that may be used to compose a visual style for the scroll bar as shown in FIG. 11 above with a named style applied to one of the sub-elements.

FIG. 13 is a listing in a mark-up language of a visual style that corresponds to FIGS. 11 and 12 that illustrates the application of a style named LineDownRepeatButtonStyle to one of the repeat button sub-elements of a scroll bar user interface element.

FIG. 14 is a listing in a mark-up language of a visual style named LineDownRepeatButtonStyle referenced by name in the listing of FIG. 13.

FIG. 15 is a block diagram illustrating a scroll viewer user interface element composed of a scroll bar wherein a change in the portion of the whole document being viewed within a scroll view area changes the size of thumb component element.

FIG. 16 is a block diagram illustrating a hierarchical tree of sub-elements for composing the scroll bar element of FIG. 15 wherein the repeat button sub-elements are illustrated along with command instructions capable of communicating changes in the functional aspects of the repeat button element to the scroll bar element.

FIG. 17 is a flow chart describing an overall process from the perspective of a programmer applying a selected style to an initially lookless user interface element FIG. 18 is a block diagram illustrating a user interface framework system comprising a user interface element factory and a style engine for rendering a user interface according to a selected style.

FIG. 19 is a flow chart describing the processing of a selected visual style using components of the user interface framework system illustrated in FIG. 18.

### DETAILED DESCRIPTION

### Exemplary UI Elements

Generally speaking, UI elements are aspects of a computer system or program which can be seen (or heard or otherwise perceived) by an end user and used to control the operation of a computer system or program through commands and other mechanisms. A graphical user interface emphasizes the use of graphical elements which are responsive to user input (e.g., mouse events, keyboard data entry etc.) for interacting with a computer system or program. Common UI elements familiar to most users include, buttons (e.g., “OK” or “Cancel), edit boxes, list boxes, combo boxes, scroll bars, pick lists, pushbuttons, radio buttons and components of World Wide Web pages (e.g., hyper-links, documents and images).

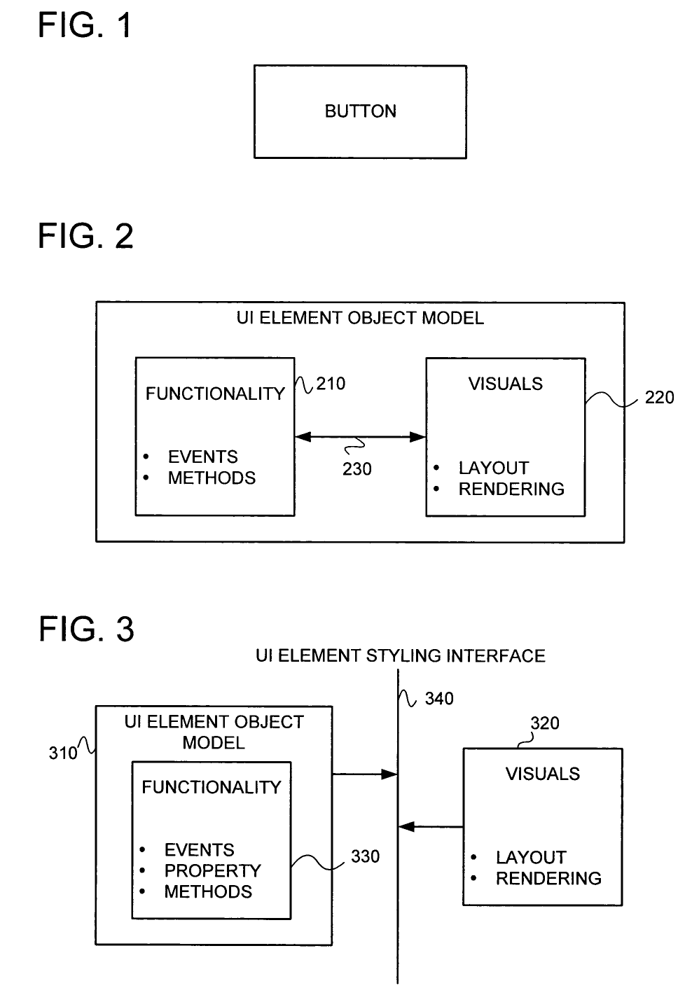

FIG. 1 is an illustration of one of the most common UI elements, a button. In order for the user interface paradigm to work as envisioned, the programmer using a UI element has to specify properties related to the UI element that define its functionality or semantics and those that define its appearance to the final user of the computer program. In traditional UI frameworks the UI element object model would comprise both the semantic and visual aspects in a tight contract such that both types of properties were generally affected by changes to the other. FIG. 2 illustrates such a model wherein the functional aspects 210 (e.g., events, methods etc.) are tied in with the visual aspects 220 in a tightly bound contract 230. Such a model presented complexities beyond the comprehension of most novice or casual programmers. For instance, changing the internal implementation of the visual rendering was not an easy proposition.

An Exemplary Method for Simplifying the Process of Defining the Visual Properties of UI Elements

One way of simplifying the process of providing greater control to programmers over defining the appearance of UI elements independently of their functional aspects is to separate their visual aspects from its functional aspects. FIG. 3 illustrates one such model 310 wherein a UI element's object model is devoid of any visual property definitions and only has its functionality defined in detail. In essence, the visual properties 320 of an UI element are separated in such a UI framework from its functional properties 330. Thus, the visual properties which are more intuitive to understand can be controlled or changed by a programmer without the need to understand its more complex semantics and functionality.

At times, these two aspects do affect each other and some mechanism may be needed for the visual aspects and the functional aspects to be connected to each other in a limited manner. Thus, a UI framework may be provided that allows for a interface 340 which can be used to not only define how the visual properties will be specified by a programmer or a programming tool (e.g., code generators etc.) but also to define a mechanism by which selected visual properties can be wired to selected functional aspects of a UI element.

An Exemplary Method of Controlling the Appearance of a UI Element by Using and Applying a Style

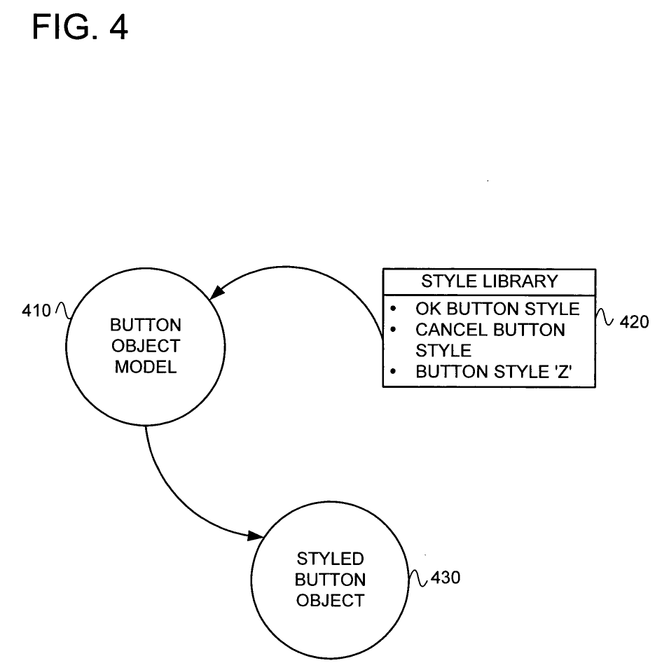

Once a UI element is defined independent of any visual aspects for rendering (hereafter, a lookless UI element), a style indicative of its visual aspects or properties may be chosen and applied to the lookless UI element to create and render a styled UI element with a specific look or visual style. For example, FIG. 4 illustrates an overall process by which a lookless object model for a button UI element 410 is associated with a style document indicative of the visual properties of a button UI element selected from a library or data base of button styles 420 to generate a styled button 430 which has an appearance as specified by the selected style document. The style documents may be a mechanism by which a desired visual style or appearance along with any interconnecting relationships of the visual properties with the functional aspects of UI element can be defined by a style author. Thus, a style document can be more than simply setting the values of visual properties of a UI element related to its appearance.

Creating a separate style outside of the object model for a UI element helps isolate the functional aspects of UI elements from their visual aspects by containing them within a separate entity. Also, a style associated with a UI element can be designated as a property of the UI element itself. Thus, applying a style (e.g., the process of going from 410 to 430) for a UI element may be thought of as setting its style property to be associated with a selected style document (e.g. from a style library 420).

### An Exemplary Style Document

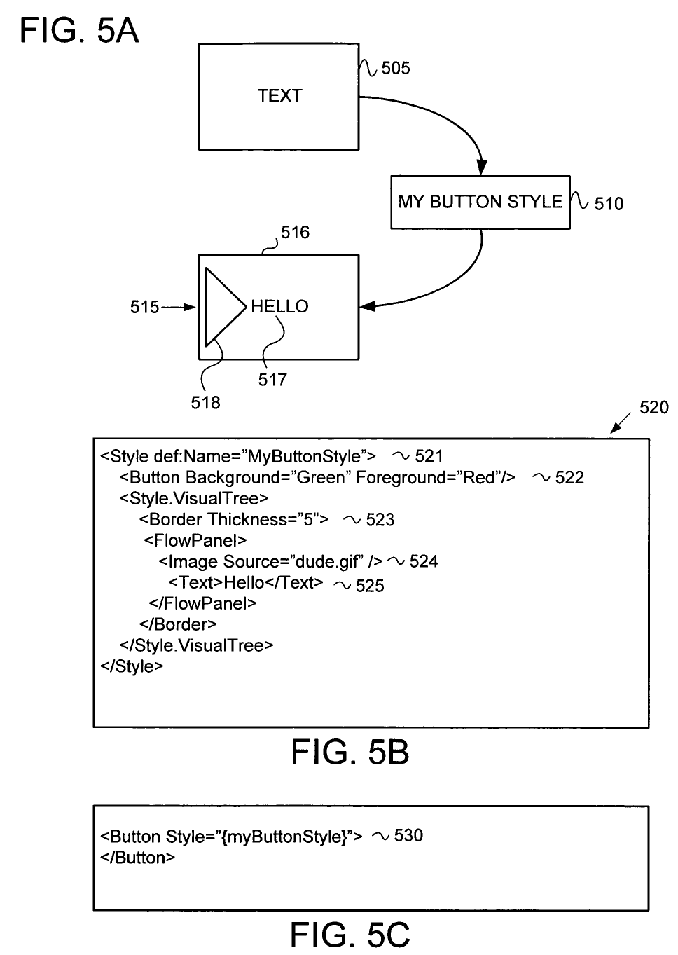

FIGS. 5A, 5B and 5C illustrate defining a style document, applying a style document and setting the style property for a UI element to be associated with a style document respectively. For instance, a programmer may want to improve an ordinary button 505 in FIG. 5A and apply a visual style identified as “MyButtonStyle” at 510 so that the appearance of the button now is as shown at 515. The look or style as shown at 515 may be achieved by applying the style 510 to a lookless UI element of the type button. However, UI element 505 with an ordinary look or style cannot be thought of as a lookless UI element because it may have a default look or some other initialized style associated with its style property.

The style 520 (510) may be a document (e.g., in XML mark-up language) that is descriptive of a look or visual style for a UI element. The document may be prepared by a style author and stored in a style library as an object of a style class, which may be later accessed by a programmer who may be able to use the style to achieve a desired look. However, a control author creating the UI framework also may have defined a style associated with a specific UI element class, which may be automatically applied to a UI element when it is first instantiated by an application program (e.g., a default style). This may be changed later by a programmer wishing to change the default look by specifying a style.

At 521 the style is named “MyButtonStyle.” Once a name is associated with a style the style may be invoked or applied by simply using its name (also referred to as resource name). The tags in the style 520 also identify it as having a target type which in this case is a button type. In general, a style may be resolved by target type or by name. A style will be applied to all the UI element's instances whose type matches that of the target type unless a program component explicitly overrides it by locally assigning a style by name or if a different style is defined for the same target type nearer in scope to the particular instance of a UI element object.

Further as shown in the example style 520, any of the properties of the button or its component sub-elements can be assigned specific values. For example, the button background property is specified as “Green” and the button foreground property is specified as “Red” at 522. As noted above, many UI elements including a simple button have sub-elements that consume other properties that affect the look of a UI element. Thus, as shown at 523, the border element's thickness property is set to ‘5.’ At 524, a resource name for an image is specified as “dude.gif.” Also, at 525 the text to be displayed within the button border is specified to be “Hello.” This style document 520 when applied to the button type UI element will be able to generate a button with a visual style as shown at 515 with a border 516 of thickness ‘5’, a text display 517 saying “Hello”, and an image 518.

To apply the style, the Button's style property may be set as shown at 530 in FIG. 5C. The style document (e.g., at 520) may be referred to as an Application Programming Interface (API). For example, the application programmer can use the style document to interface with the UI framework to specify visual properties which the UI framework can use in rendering the UI element. For instance, in the above example related to FIG. 5C 530 at the mark-up statement “<Button Style=“MyButtonStyle”> allows an application programmer to use the style document named “MyButtonStyle” as an interface to the UI framework for instructing the framework to apply a style according the “MyButtonStyle” style document which is accessible to the framework. Thus, depending on the UI framework number of different style document APIs may be generated for number of different UI element types. Multiple style documents may exist that may be applied to a given UI element type. Also, a single defined style can be applied to multiple instances of UI element objects.

The style document illustrated in FIG. 5B is a simple one wherein values of the visual properties for the Button UI element were directly specified within the style document. However, a style document can provide much more flexibility to a programmer or a style author. For instance, a style author can define a style document that allows visual properties of component elements or sub-elements of a complex or composite UI element to be exposed to an application programmer as properties of composite UI element itself. In this manner, the programmer can directly control the appearance by setting the visual properties actually consumed by the component elements without even knowing the structure and make-up of the composite UI element. Also, style documents can specify values to visual properties of a UI element by referring to a global resource which could among other things be a style document. Furthermore, the style document can also be used to specify the value of a visual property of an UI element by binding it to the property value of the property of an entirely different type of UI element. Thus, in this sense the style document can be used in a remarkable range of ways to parameterize the visual properties of a UI element separately from its functional aspects. Each method of such parameterization is described in further detail below.

An Exemplary Method of Using a Style Document for Specifying Visual Properties of a Composite UI Element Using Bindings

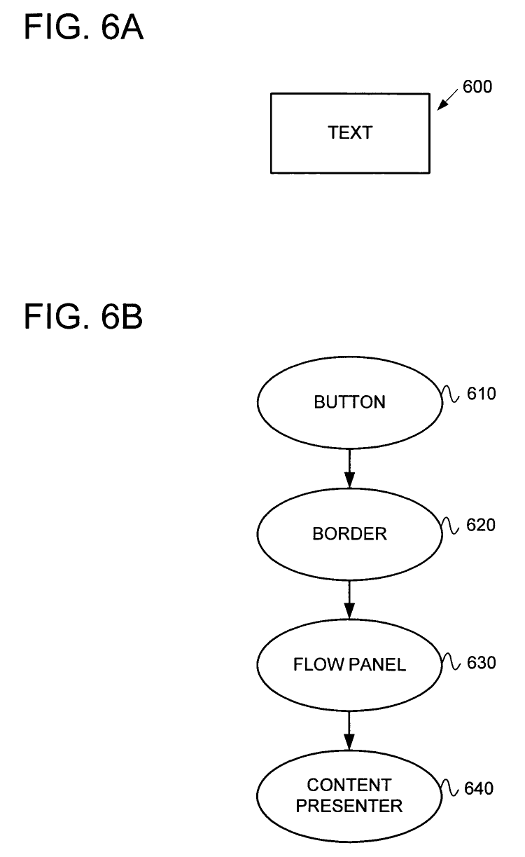

There are many examples of UI elements that are composed from sub-elements. For example, a scroll bar UI element is composed of many other sub-elements including buttons that advance the text of a scrolling display area higher or lower in the scroll view area. Even seemingly simple UI elements such as a simple button may comprise of several sub-elements. When considering the possibly thousands of types of UI elements this presents an enormous amount of information for programmer to be familiar with in order to properly program a user interface. The button 600 as shown in FIG. 6A may be composed of a number of other sub-elements as shown in FIG. 6B. The sub-elements may be represented in a tree representation showing several child UI elements as associated with a button element 610. For example, the button element 610 may be associated with a border element 620, a flow panel element 630, and a content presenter element 640. In general, the border element 620 relates to the border of the button, the flow panel element 630 relates to alignment of any content to be displayed the within the button, and the content presenter 640 relates to actual content of the button. Each of these sub-elements can be defined to have a set of properties that affect the appearance of the UI element. However, a novice or a casual programmer may not want to understand or view the entire hierarchical tree representation of the sub-components or sub-elements of a composite UI element. However, a style document (as described below) can be used to hide the complexities of a composite UI element from such a programmer.

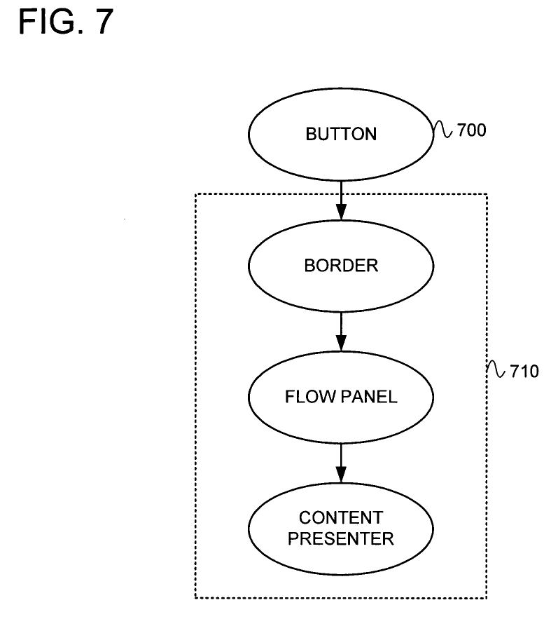

Essentially, a style document can be authored that when applied to a UI element is capable of hiding the complexities of a composite UI element as shown in FIG. 7 such that the logical model exposed to a programmer shows the button element 700 as a stand alone UI element not composed of any other UI elements which may have a number of different visual style properties whose values can be individually specified. The sub-elements shown enclosed or hidden at 710 by the use of a style document essentially remain anonymous to the application programmer.

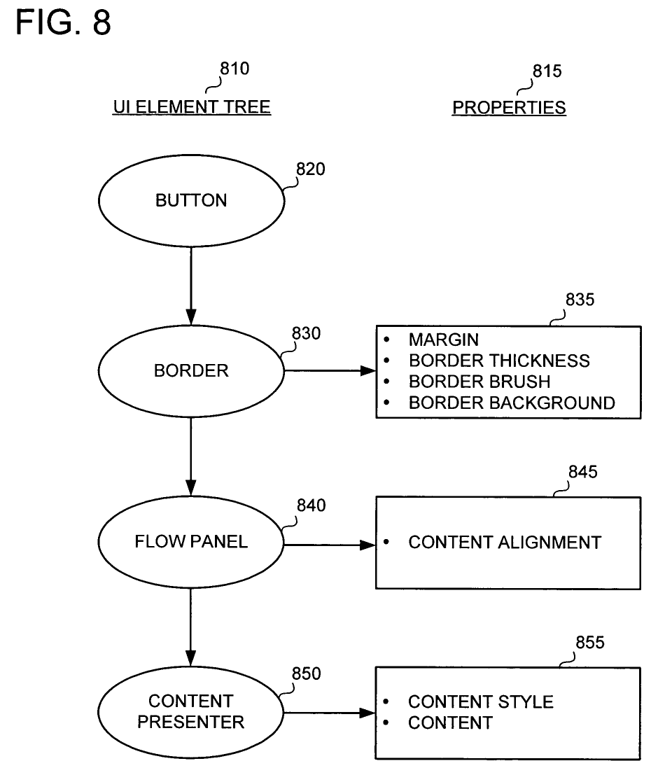

In this manner, the novice user can interact with the logical model 700 in contexts such as to assign values to visual properties which may appear to the programmer as belonging to the button without the need to understand the entire tree structure of the composite button UI element needed to render the composite UI element. For instance, in a hierarchical representation of button UI element the properties consumed by the various sub-elements may be listed as shown in FIG. 8 wherein column 810 refers to the element composition of the button UI element 820 and column 815 refers to the corresponding properties that may be associated with each of the sub-elements. The description of FIG. 8 is only meant to be illustrative since even a button element may be composed of different combinations of sub-elements which in turn may be associated with different properties affecting their appearance. In any event, as shown in FIG. 8, the border sub-element 830 may be associated with its own set of properties 835 (e.g., margin, border thickness, border brush, and border background). Also, the flow panel UI element 840 may be associated with its own set of properties 845 (e.g., content alignment) and the content presenter UI element 850 may be associated with its own set of properties 855 (e.g., content style and content).

Traditionally, for an application programmer to specify the properties consumed by the sub-elements of a button UI element for example he or she would have to be aware of the composition of the hierarchical tree representing the visual components of a button element. Furthermore, he or she would also have to be intimately aware of which properties are consumed by which of the sub-elements. For example, to set the content property of the content presenter UI element 850 he or she would have to know that that the complex button UI element 820 is composed of a sub-element content presenter 850 which consumes a content property. This also restricted the UI framework developers in offering radically different visual models of UI elements for the fear of confounding an ordinary programmer used to a certain UI component paradigm.

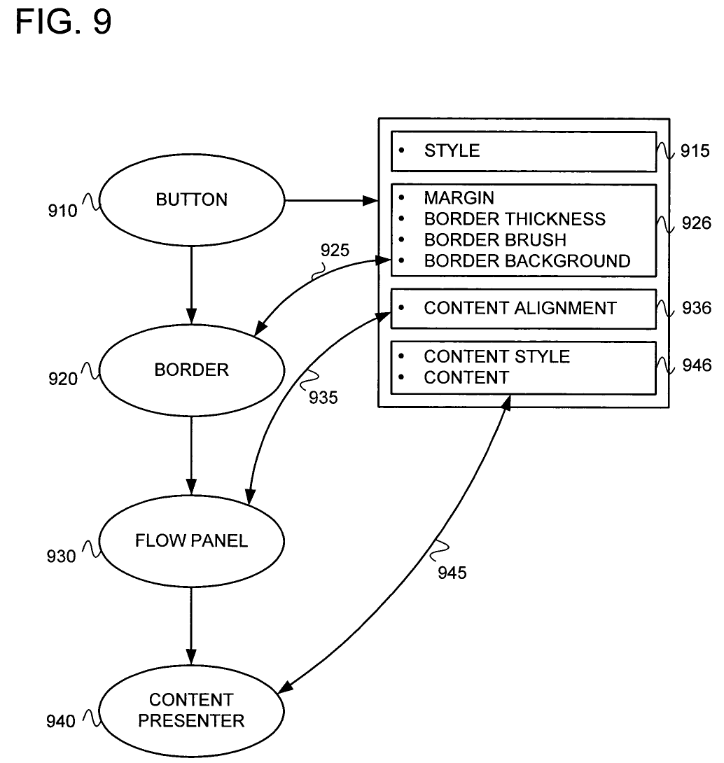

However, such complexities may be hidden from a selected subset of programmers by using a style document to selectively expose properties consumed by sub-elements as the properties of the composite UI element. Using the example of a button, as shown in FIG. 9, the properties normally presented to an application programmer as being associated with sub-elements (e.g., 830, 840 and 850) may now exposed at the level of the composite button UI element 910. This may be accomplished by setting style property 915 of the button element 910 to be associated with a style document that specifies bindings (e.g., 925, 935 and 945) that associate the properties exposed at the complex button UI element 910 to the appropriate sub-element that actually consumes the property.

As shown in FIG. 9, the border sub-element 920 can be bound via a binding 925 to the properties 926 of the button element (e.g., margin, border thickness, border brush, and border background) to consume such properties even if these properties are provided a value by a programmer as properties of the composite button UI element 910. Similarly, the bindings 935 may be specified to bind the properties 936 (e.g., content alignment) to the flow panel sub-element 930 for its consumption and the bindings 945 may be specified to bind the properties 946 (e.g., content style and content) to the content presenter 940. This effectively hides the complexities of the tree structure from the novice programmer and directs the properties set by such programmers to the appropriate sub-element for consumption. For example, once the appropriate bindings are in place, the content property from 946 may be exposed as the property of the button UI element 910 and thus, a programmer can now specify the content property with the following simple line of instruction:
Button.Content=“TEXT”;
The above simple instruction format for setting the content property does not require that the programmer be aware of the button UI element's composition of visual sub-elements.
An Exemplary Style Document with Property Bindings Included in a Visual Element Tree

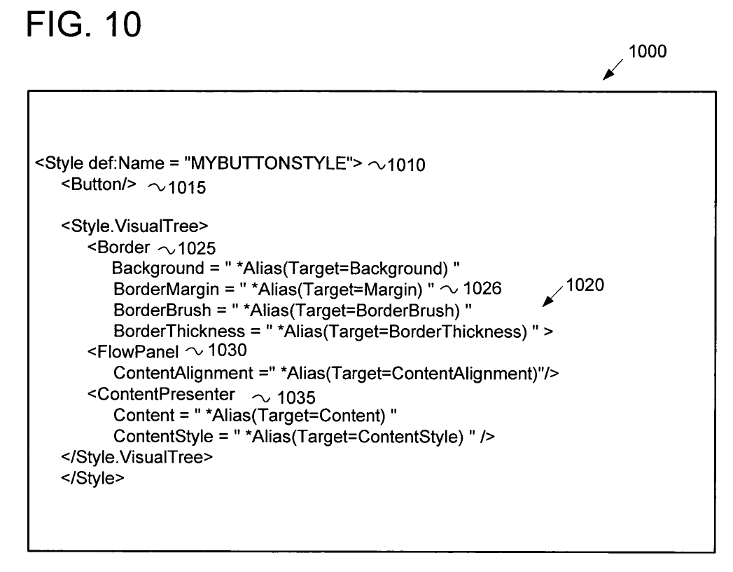

The style document associated with the style property 915 may be defined in a mark-up language as shown in FIG. 10, which illustrates a representation of the style document in the Extensible Mark-up Language (XML). Similar, representations may be easily created using other mark-up languages provided that an appropriate parser is available to parse a style document in the particular mark-up language. Furthermore, the style document may be created even using programming languages (e.g., C#, C++, Java etc.). The style definition 1000 of FIG. 10 illustrates a method for binding properties of sub-elements (e.g., 830, 840 and 850) to be exposed as properties of the complex Button UI element (e.g., 820). The style definition begins with a name designated for the style at 1010 wherein the style is named “MyButtonStyle.” Naming the style allows the style definition to be invoked by other style documents allowing for recursive nesting of style definitions within other style definitions. Also, the tag at 1015 “<Button/>” identifies that the MyButtonStyle is to be targeted to an UI element of button type. An exception may be thrown if a programmer tries to apply a style associated with a certain type of UI element to a UI element of a different type.

Next, at the “<Style.VisualTree>” the style document begins to list the sub-elements composed to form the button UI element, which may be thought of as a property of the style itself (e.g., referred to as the visual tree property). The visual tree property can be thought of as listing a factory of UI elements, which instruct components of a UI frame work to instantiate the sub-elements specified within the visual tree property in accordance with any properties that may be defined for such sub-elements. For instance, the visual tree property 1020 of the MyButtonStyle indicates that the MyButtonStyle to be applied to a button type is to have a border element 1025, flow panel element 1030 and a content presenter element 1035. Between the tags identifying each of the sub-elements, several bindings are specified that designate which properties are to be exposed as properties of a button type to be actually consumed as properties of one of the sub-elements specified within the visual tree property. For instance, the declarative mark-up statement “<Border Margin=”* Alias (Target=Margin)”/> at 1026 binds the margin property of the sub-element border 1025 to the margin property of the button element itself. Thus, if the MyButtonStyle 1000 is applied to a button UI element then a programmer can specify a margin property for such a button UI element directly by using the following simple instruction:
Button.Margin=1.25
Similarly, the properties for the rest of the sub-elements flow panel at 1030 and the content presenter 1035 have been specified as bound to be exposed as properties of the target UI element of the MyButtonStyle 1000. In this instance that happens to be a button UI element.

All of the listed properties to be consumed by the sub-elements are shown in the MyButtonStyle 1000 as being exposed at the button UI level (e.g., as shown in FIG. 9). However, an author designing a style such as MyButtonStyle 1000 can select only few of the properties of the sub-elements to be exposed in this manner. For instance, the MyButtonStyle 1000 lists border sub-element 1025 as having properties of margin, background, brush and thickness. Instead of choosing to bind all of these properties to corresponding properties on a button UI element a style author may chose to bind only a few such properties to be exposed. The rest of the properties may be set in other ways. For example, the style author may specify a value for the background property directly within the style document. Thus, when a programmer chooses that style to be applied to a button UI element he or she will not be provided an interface to set the background property. Instead the background property value as specified by the style author will be used. This allows a style author control over how much of the capability to customize a UI element's visual properties is to be provided to an application programmer. However, an application programmer can also author a new style or edit an existing style, and have access to a visual tree and thus, to that extent they too can have precise control over specifying visual properties of a UI element.

An Exemplary Method for Defining a Style Property Including References to Resources

Separating the specification and control over visual properties of a UI element from its functional aspects can provide a great deal of flexibility in generating a selected look for UI elements. Creating a style document that is not married to a UI element's functional aspects that can later be applied to selected UI elements is what provides such flexibility. Within a style document visual properties can be defined in a number of ways. For instance, as described above using a visual tree and related bindings selected properties may be exposed on composite UI elements to be set by an application programmer. Also, properties can be set directly by the style author within the style document itself. One way of specifying a property value within a style would be set to a value directly within the style. Yet another way to set a value would be to refer to another resource defined outside of the style document itself.

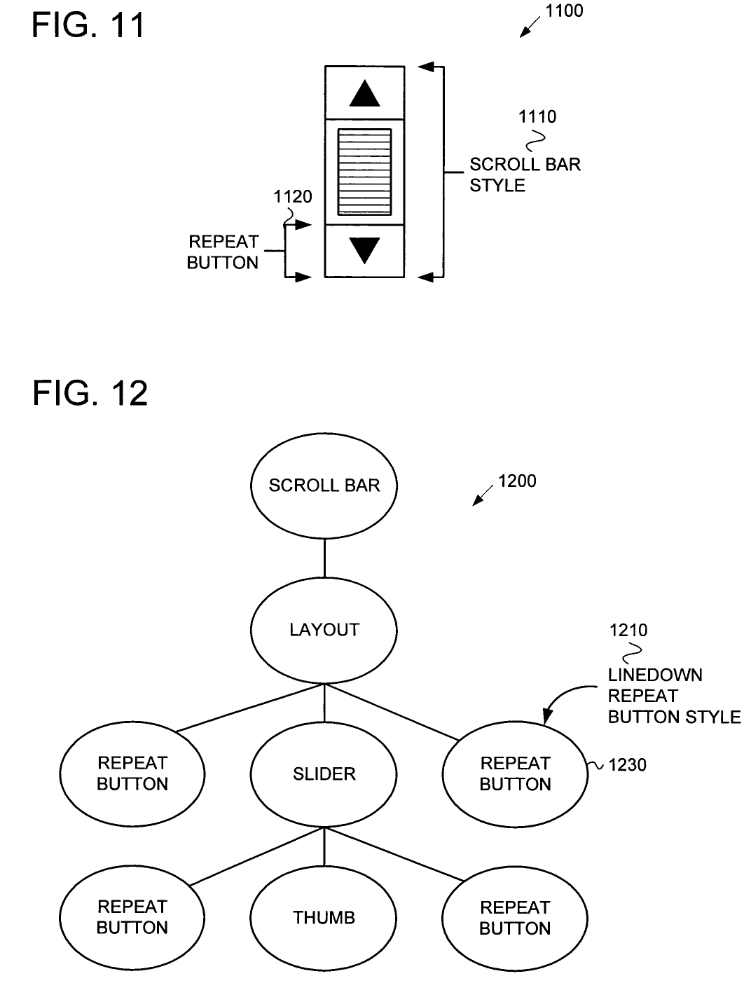

For instance, FIG. 11 illustrates a vertical scroll bar UI element 1100. Suppose a style 1110 has been defined for a scroll bar UI element type that includes the visual properties for rendering the repeat button 1120. In that event, if the visual properties of the repeat button 1120 was specified in the scroll bar style 1110 directly then each time a value change has to be made to the repeat button's visual properties the style of the entire scroll bar has to be changed in effect. However, if the repeat button's visual property values were set outside of the style document of the scroll bar 1110 in a named resource and the scroll bar style merely provided a pointer to such a named resource for obtaining the visual properties associated with a repeat button then a change can be made globally to the named resource without making any changes to the scroll bar style 1110. This also helps hide complexities related to understanding the sub-elements composing each UI element.

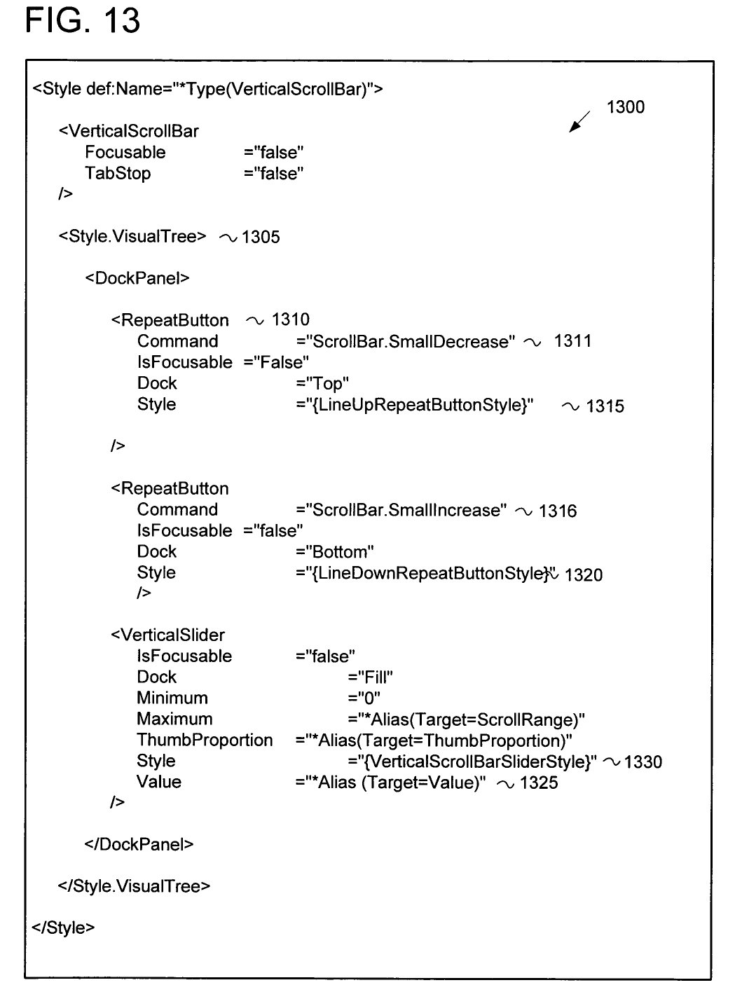

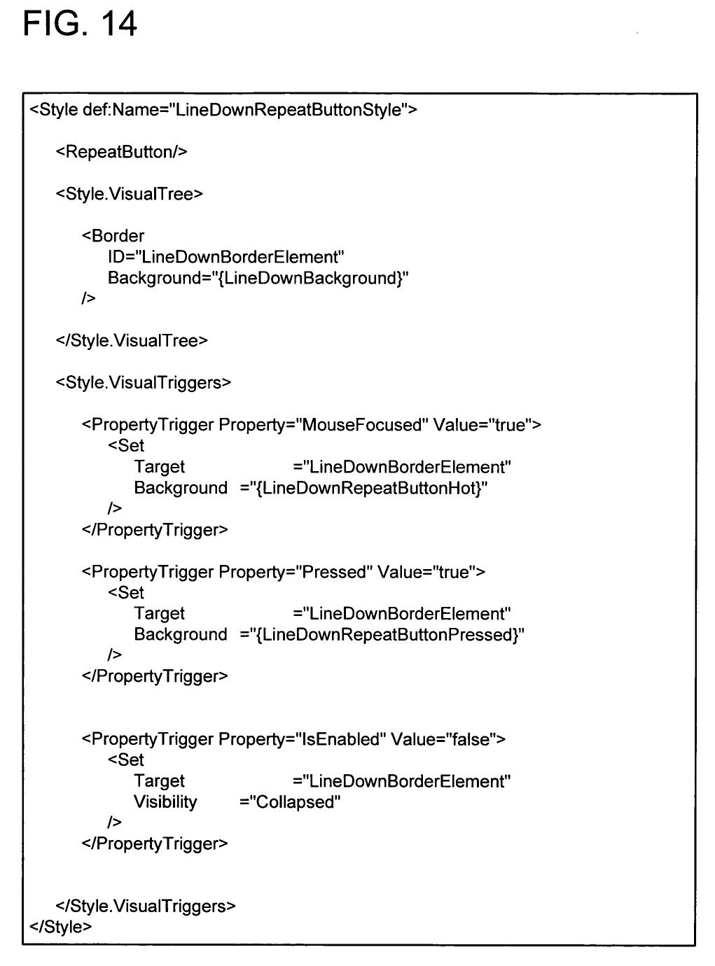

FIG. 12 illustrates one way of using named resources. FIG. 12 illustrates a visual tree 1200 for the scroll bar wherein a style named “LineDownRepeatButtonStyle” is applied to one of the repeat button sub-elements at 1230. In this manner, the style associated with the entire visual tree can refer to the LineDownRepeatButtonStyle 1210 which is defined outside scroll bar style document. FIG. 13 illustrates a style 1300 for a scroll bar that uses named resources to set values for its component elements. The visual tree for the style 1300 includes a line down repeat button sub-element 1310 that corresponds to the repeat button 1120 of FIG. 11. Within the scroll bar style 1300 the visual properties of the repeat button 1310 is specified by referring to a named style “LineDownRepeatButtonStyle” at 1315. The “LineDownRepeatButtonStyle” may then be defined in a separate style document as shown in FIG. 14. Similar, named references are used for defining the visual properties of the other repeat buttons at 1320 and the vertical slider at 1330.

Although, the example above illustrates specifying visual properties for sub-elements by setting style properties, other individual properties too can be provided a value by referring to a global resource defined outside of the style document referring to it. For example, background property for a button can be defined as a resource named MySpecialBackground and the value for such a background may be set in a resource file outside of the style documents consuming the property. The named resource may be changed independently which then changes the background property for all the style documents that refer to the named resource. Such ability to change visual properties at a more global scope simplifies coding and makes it easier for large group of developers to provide a consistent theme for the look and feel of UI elements in a program.

An Exemplary Method for Selectively Wiring Visual Properties of a UI Element to Functional Aspects

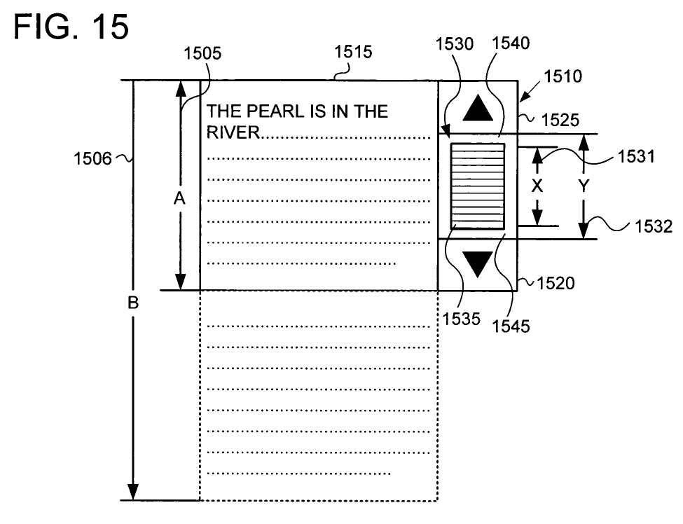

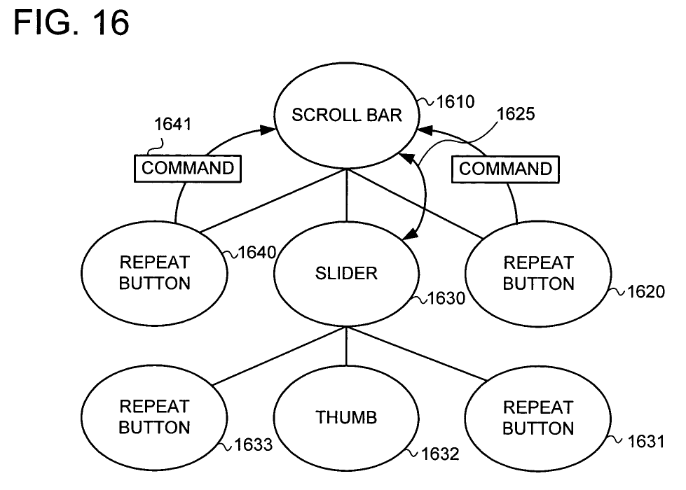

In a model such as the one described above where the functional aspects of a UI element are separated from its visual aspects there needs to be mechanisms whereby the visual properties of UI elements and their functional aspects are wired to each other in a selective manner. This may be needed in those circumstances where the functional aspects of a UI element that allow for interactions with a user do affect the appearance of the UI elements themselves or even the appearance of other UI elements. For instance, as shown in FIG. 15, a scroll bar 1510 which allows a user to view a document much larger than what is visible in a scroll viewer 1515 is a complex UI element that may be composed of other sub-elements (e.g., repeat buttons 1520 and 1525, slider 1530 etc.). Furthermore, some of these sub-elements themselves may be composed of other sub-elements (e.g., a slider 1530 may be composed of a thumb 1535, and two other hidden repeat buttons 1540 and 1545). As shown in FIG. 16 the scroll bar may be represented as a visual tree composed from a scroll bar's sub-elements. The scroll bar is shown composed of repeat buttons 1620 and 1640 and a slider 1630. The slider 1630 in turn is composed of two other repeat buttons 1633 and 1631 and a thumb 1632.

In some instances, user interactions with one of the sub-elements can affect the properties of other UI elements. For example, in FIG. 15 the appearance of the thumb position 1535 may be affected by user interactions with the repeat buttons 1525 and 1520. In this example, the proportion of size X at 1531 of the thumb to size Y at 1532 of the slider 1530 is the same as the proportion of the visible portion size A at 1505 of a document to the size B at 1506 of the rest of the document that is below the portion being viewed. However, the class definition for the scroll bar type does not list the visual tree representation shown above which would bind the scroll bar to its children. In fact, the scroll bar itself may not be aware of its own children and the user triggered events related to its children. Therefore, in one implementation it is possible to provide a set of declarative commands that can be triggered upon selected user interactions (e.g., click event) related to functionality or semantics of the control. These declarative commands can then be wired to drive the behavior of other UI elements without the need to add code or logic to handle the events.

The functionality of the declarative commands can be illustrated further using FIGS. 13 and 16 which describe the behavior of a scroll bar that can be wired using declarative commands. For instance, the object model of the scroll bar 1610 is not aware of its child repeat button element 1640. Thus, when a repeat button is clicked the scroll bar is not aware of the state change within the repeat button 1640 that could in fact affect changes in the scroll bar's properties. However, a style document 1300 as shown in FIG. 13 can be used that defines a declarative command 1311 (1641) associated with the repeat button 1310 (1640) that is triggered upon a click event. Since, the declarative command is defined within the visual tree 1305 associated with the scroll bar's style 1300, in essence, the scroll bar can be programmed to respond to such command events. Thus, the scroll bar can be programmed to respond to all the declarative commands that are exposed (e.g., 1311 and 1316).

ScrollBar 1610 may respond to these commands by appropriately updating its own properties. For example, ScrollBar's 1610 value property may be updated as a result of acting on a command 1641. This, in turn, is consumed through a binding 1625 (1325) by the Slider element 1630 that is in the ScrollBar's 1610 visual tree. Slider element 1630 may then use this value to update the position of the thumb element 1632 in its style. In this manner, a composite UI element can be selectively wired in a loose contract with its component elements without the need to define the entire set of components within the class definition of the composite UI element. This increases code reuse and reduces the overall amount of coding to be done in order to relate the behavior of two separate UI elements.

Exemplary Processing of Style Documents for Applying Visual Styles to Look Less UI Element Objects

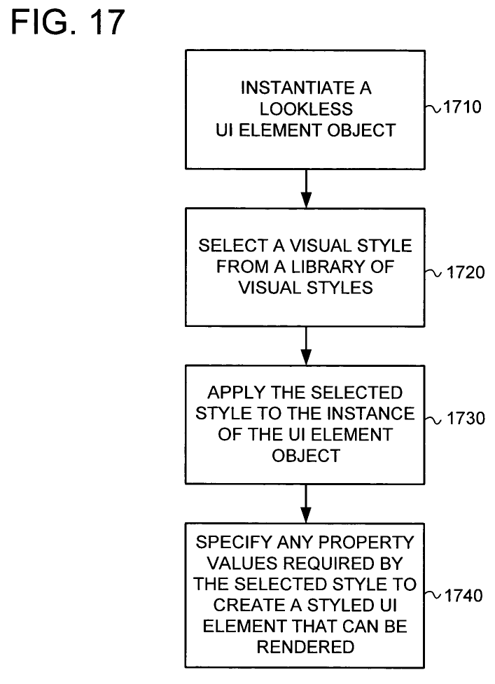

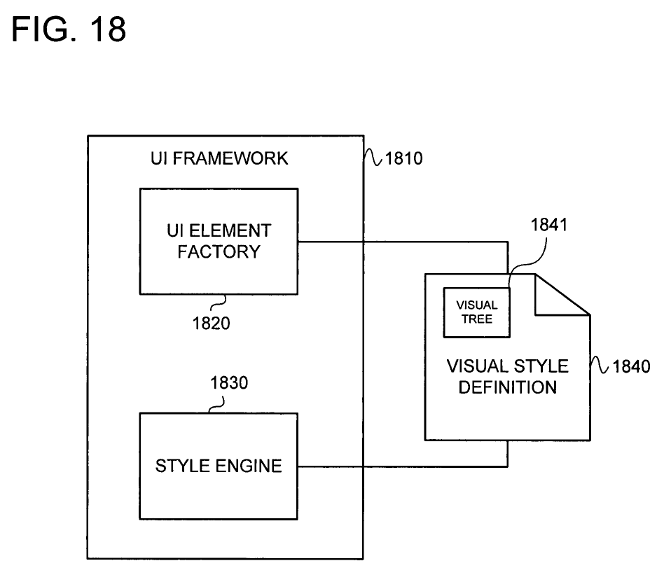

From the perspective of an application programmer the process for applying a selected visual style to an UI element may be as described in FIG. 17. At 1710, the user instantiates a lookless UI element object. Then at 1720, the user may select a particular visual style from a library or a database of styles. Then at 1730, a style may be applied to all UI elements of a certain type or the style may be applied by name to selected UI elements. Thus, it is not always necessary to name a style and later apply it by name to a UI element. As noted above, some styles may provide an interface to specify selected properties of sub-elements of a visual tree of composite UI element. These properties once specified at 1740 may be consumed by the appropriate sub-elements and used to render the visible composite UI element.

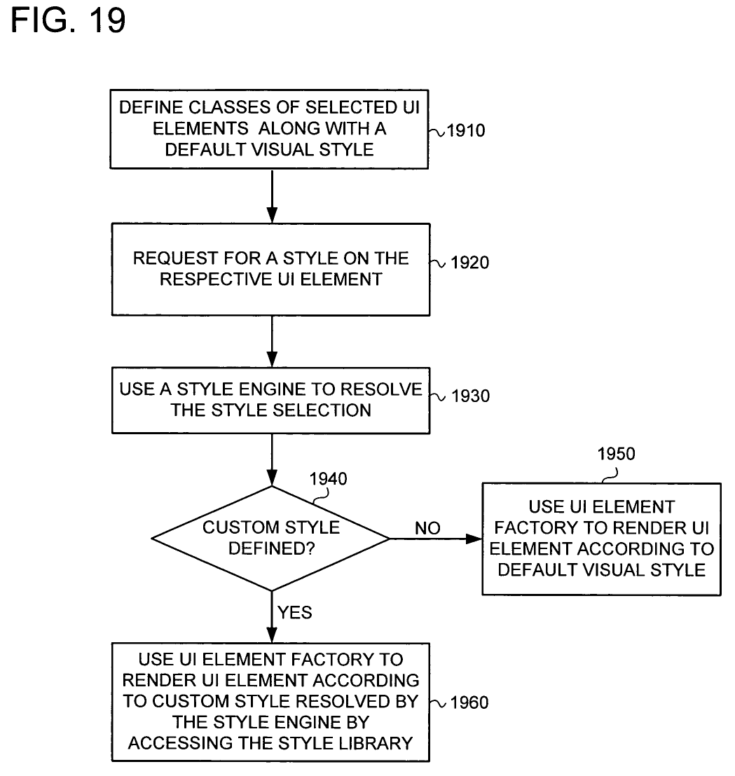

The processing of a style applied by a user (e.g., an application programmer) as described above with reference to FIG. 17 may be further illustrated with reference to FIGS. 18 and 19. A UI framework 1810 may be provided which comprises a style engine 1830 and a UI element factory 1820. The UI element factory 1820 may be programmed to instantiate sub-elements belonging to a visual tree 1841 described by a style document 1840. The style engine 1830 may be used to resolve which style is to be applied to an instantiated and initially lookless UI element object. Although, FIG. 18 shows a single style it is likely that more than one style is associated with the UI element type and style engine would be able to analyze the scope of style definitions and apply the right kind of style. The UI element factory creates new instances of the sub-elements making up a visual tree not simply clone existing instances of the sub-elements. In this manner, the complexity surrounding persistent identification of various clones of the same instance of a sub-element object is avoided.

Thus, the method of processing an instruction to apply a style (1730) to a look less UI element object may be described as shown in FIG. 19. Prior to a user applying a style the author of the UI element class who may have also created the UI framework 1810 would have specified at 1910 the class definition of a UI element along with a default visual style that would be initially associated with all UI elements of that type. This may be needed to increase the out of box experience of using controls for a programmer because they would have access to at least a default level of visual interaction with a given UI element. Then at 1920, when a request for a style occurs on a UI element, at 1930, a style engine is used to resolve the style selection. At 1940 if a custom style has not been specified, the style engine will use the default style that was specified by the type itself and at 1950, the UI element factory may be used to instantiate the sub-elements and render the UI element according to its default visual style. However, at 1940, if a custom style has been defined, then at 1960, the UI Element factory 1820 may be used to instantiate the sub-elements specified in the visual tree associated with the custom style and the UI element may be rendered according to the custom style specified. In this manner, a UI element factory 1820 can be used in conjunction with a style engine 1830 to resolve the applied style and render the UI element according to the visual style definition 1840.

### Alternatives

Having described and illustrated the principles of our invention with reference to the described embodiments, it will be recognized that the described embodiments can be modified in arrangement and detail without departing from such principles. For instance, many of the examples have been expressed using the XML mark-up language. However, the same may be expressed in code. Also, the functionality of declarative bind and command statements for wiring can be expressed in code as well.

Also, it should be understood that the programs, processes, or methods described herein are not related or limited to any particular type of computer apparatus. Various types of general purpose or specialized computer apparatus may be used with or perform operations in accordance with the teachings described herein. Actions described herein can be achieved by computer-readable media comprising computer-executable instructions for performing such actions. Elements of the illustrated embodiment shown in software may be implemented in hardware and vice versa. In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. Computer readable media having encoded thereon a data structure representing a visual style to be applied to one or more object instances of a lookless user interface element for rendering the user interface element according to the visual style, the data structure comprising:
a visual tree comprising a hierarchy of one or more sub-elements of the user interface element to be used by user interface services for composing and rendering the user interface element; and
one or more bindings between visual properties of the user interface element and corresponding properties of its sub-elements, wherein the sub-elements consume values associated with bound properties of the user interface element for rendering the user interface element according to the visual style.

2. The computer readable media of claim 1, wherein each of the one or more bindings are between a single visual property of a user interface element to a single corresponding visual property of a sub-element.

3. The computer readable media of claim 1, wherein each of the bindings are expressed in a declarative statement.

4. The computer readable media of claim 3, wherein the declarative statement comprises a target property associated with the UI element and a source property associated with a corresponding one of the sub-elements.

5. The computer readable media of claim 4, wherein a syntax for the declarative statement indicative of the binding comprises SourceProperty=“*Alias (Target=Property)”.

6. The computer readable media of claim 1, wherein the data structure further comprises one or more visual properties of the user interface element with values corresponding to one or more named resources.

7. The computer readable media of claim 6, wherein the one or more of the named resources is a named style.

8. The computer readable media of claim 1, wherein the data structure further comprises at least one visual property of at least one of the sub-elements with values corresponding to one or more named resources.

9. The computer readable media of claim 8, wherein one or more of the named resources is a named style.

10. The computer readable media of claim 1, further comprising a command instruction for driving changes in the visual aspects of the user interface element via changes to the functional aspects of the sub-elements.

11. The computer readable media of claim 10, wherein the command instruction is associated with an indicator that is indicative of one or more of the changes to functional aspects of the sub-elements that may be caused by user interaction.

12. The computer readable media of claim 1, further comprising a command instruction for causing a change in the visual properties of the UI element due to an event causing a change in the functional aspects of one of the sub-elements.

13. In a computer system operating according to an operating system comprising a user interface service, a method of applying a visual style for rendering a user interface element on a display according to the visual style, the method comprising:
determining which one of one or more visual styles related to a type of the user interface element is to be applied to the user interface;
retrieving one or more style documents describing the determined visual style; wherein the one or more style documents comprise a description of a visual tree including one or more sub-elements of the user interface element; and
using the visual tree description to generate instances of the sub-elements of the user interface element and selectively binding visual properties of the sub-elements to consume corresponding properties of the user interface element for rendering the user interface element according to the determined visual style.

14. The method of claim 13, wherein the determining which one of the one or more styles to apply is based on a type of the user interface element.

15. The method of claim 13, wherein the determining which one of the one or more styles to apply is based on a name related to a visual style assigned by name to the user interface element.

16. The method of claim 13, wherein the determining which one of the one or more styles to apply results in a default style being applied.

17. The method of claim 13, further comprising parsing the one or more style documents related to the determined visual style for named resources corresponding to visual style properties for rendering the user interface according to visual property values specified by the named resources.

18. The method of claim 17, wherein the named resources are defined in a document independent of the one or more style documents related to the visual style.

19. The method of claim 17, wherein one or more of the named resources is a named style associated with another one of a type of user interface element.

20. The method of claim 13, further comprising using command instructions included in the one or more style documents for driving changes in properties of the user interface element.

21. The method of claim 20, wherein the command instructions are executed upon a change in functional aspects of the one or more sub-elements of the user interface element.

22. The method of claim 20, wherein the properties to be changed are consumed by another one of the sub-elements according to a binding indicated in the determined visual style document.

23. In a computer system having an operating system platform, a user interface framework system for rendering a user interface element composed of sub-elements according to a visual style defined for the user interface element type, the system comprising:
a lookless definition of the user interface element;
a style library for holding one or more visual style documents to be selectively applied to the lookless user interface element for rendering the initially lookless user interface element;
a style engine for resolving which of the one or more visual style documents is selected to be applied to the user interface element; and
a user interface element factory for creating instances of sub-elements for composing the user interface element according to the selected visual style document for rendering.

24. The system of claim 23, wherein the user interface element factory instantiates sub-elements according to the selected visual style document comprising a description of a visual tree of the sub-elements used for composing the user interface element.

25. The system of claim 23, wherein the selected visual style document comprises bindings between the user interface element and its sub-elements and the user interface framework system is operative for exposing selected visual properties of the sub-elements as visual properties of the user interface element itself according to the bindings.

26. The system of claim 25, being further operative for enabling the sub-elements to consume values of their visual properties correspondingly associated with the visual properties of the user interface element according to the bindings.

27. The system of claim 23, wherein the selected visual style document comprises at least one specification of one or more visual properties having values corresponding to one or more named resources and the user interface framework system is operable for rendering the user interface element according to the specification.

28. The system of claim 27, wherein the one or more named resource is a named style.

29. The system of claim 27, wherein the one or more named resources are defined independently of the selected visual style document.

30. The system of claim 23, wherein the selected visual style document comprises one or more command instructions and the user interface framework system is operable for causing changes in properties of the user interface element according to changes in functional aspects of the sub-elements as indicated by the command instructions.
